(19) United States
(12) Patent Application Publication
(10) Pub. No.: US 2024/0195190 A1
(43) Pub. Date: Jun. 13, 2024

(54) POWER SUPPLY DEVICE

(71) Applicant: Prime Planet Energy & Solutions, Inc., Tokyo (JP)

(72) Inventors: Syuichi HORII, Kusatsu-shi (JP); Jun KIKUCHI, Kakogawa-shi (JP); Atsushi HIRAYAMA, Suita-shi (JP)

(21) Appl. No.: 18/500,114

(22) Filed: Nov. 2, 2023

(30) Foreign Application Priority Data
Dec. 9, 2022 (JP) 2022-197280

(51) Int. Cl. H02J 7/00; H01M 10/42; H01M 50/51

(52) U.S. Cl. CPC H02J 7/0014; H01M 10/425; H01M 50/51; H02J 7/0048; H01M 2010/4271

(57) ABSTRACT

A higher-level controller is configured to execute a first process of setting an adjusting value for adjusting a target value that is set by a plurality of lower-level controllers of a plurality of battery modules. The lower-level controllers are configured to execute a second process of updating the respective target values that are set by the respective lower-level controllers.

### CROSS REFERENCE TO RELATED APPLICATIONS

The present application claims priority from Japanese Patent Application No. 2022-197280 filed on Dec. 9, 2022, which is incorporated by reference herein in its entirety.

### BACKGROUND

The present invention relates to a power supply device.

JP 2003-47111 A discloses a power supply device for an automobile. The power supply device disclosed in the publication includes a battery pack in which a plurality of divided units are connected in series, a plurality of battery status detection circuits connected to the respective divided units, and a battery ECU connected to each of the battery status detection circuits via an external communication bus. Each of the battery status detection circuits includes a voltage detector, an A/D converter, a unit arithmetic circuit, and a communication circuit. The battery status detection circuit detects the status of each of the divided units with the unit arithmetic circuit, and transmits the detected status of the divided units to the battery ECU. That is, according to the technology disclosed in the publication, the status of each divided unit is detected and transmitted to the battery ECU. Such a configuration makes it possible to detect the statuses of the divided units composed of battery modules independently and in more detail while reducing the load on the battery ECU and using inexpensive parts. It is stated that advantageous effects include improvements in reliability and safety in collision and reduction in errors due to noise to more accurately detect the statuses of the divided units.

JP 2014-68524 A discloses a power supply device including a a battery pack having a plurality of secondary battery cells connected in series, and a plurality of discharge circuits respectively connected in parallel with the secondary battery cells to discharge the corresponding secondary battery cells. A charge control circuit performs constant current charging to the battery pack. When the voltage of one or plurality of the secondary battery cells reaches a predetermined first voltage, the charge control circuit drives the discharge circuit connected to the one or plurality of the secondary battery cells having reached the first voltage to cause the one or plurality of the secondary battery cells to discharge, and performs constant voltage charging to the battery pack. When the voltage of the secondary battery cell that is discharged has reached a predetermined second voltage that is lower than the first voltage, the charge control circuit causes the secondary battery cell to stop discharging, and repeats the charging process from the constant current charging to the stop of discharging again. It is stated that such a configuration makes it possible to sufficiently use the capacity of all the secondary battery cells that constitute the battery pack device and provide sufficient effective capacity.

WO 2012/053426 A discloses the following. Although provision of a control circuit, such as a microcomputer, for each battery module enables high-level control management, it requires a complicated electronic circuit to be provided for each battery module, resulting in an extremely complicated circuit configuration, cumbersome processing, and moreover, increases in manufacturing costs and management and maintenance costs. In particular, for mass-produced on-board power supply devices, there is a strong demand for cost reduction, which requires a simpler and less expensive configuration. The power supply device disclosed in the publication includes a battery block including a plurality of battery cells that are stacked and connected in series and/or in parallel, a battery status detection unit for detecting the status of the battery cells, a communication interface for communicating data with other functional modules or a main controller, and a memory unit capable of recording the data communicated via the communication interface. The main controller is connected to a plurality of functional modules and communication interfaces of the respective functional modules via a communication line. The plurality of functional modules are connected in series and/or in parallel on an output line. The publication states that such a configuration simplifies the overall structure by eliminating the computing function from the functional modules and causing the main controller to collectively perform the computing itself. The publication also states that manufacturing costs may be reduced by commonizing the hardware configuration among the functional modules. In addition, the publication states that even when a failure occurs in some of the functional modules, only the failed functional modules need to be replaced, which is advantageous in terms of maintenance.

### SUMMARY

For a power supply device incorporating a plurality of battery modules, the larger the number of batteries incorporated therein, the more complicated the computation for the equalization process tends to be.

According to the present disclosure, a power supply device includes a plurality of battery modules connected in series, and a higher-level controller. Each of the plurality of battery modules includes: a plurality of battery cells connected in series; a detection unit detecting respective remaining capacities of the plurality of battery cells; a lower-level controller configured to execute a process of setting a target value for equalizing the remaining capacities of the plurality of battery cells based on the remaining capacities of the plurality of battery cells that are detected by the detection unit; and an equalization processor for equalizing the remaining capacities of the plurality of battery cells according to the target value set by the lower-level controller. The higher-level controller is configured to execute a first process of setting an adjusting value for adjusting the target value set by the lower-level controller of each of the plurality of battery modules. The lower-level controllers are configured to execute a second process of updating the respective target values that are set by the respective lower-level controllers.

Such a power supply device requires a less amount of arithmetic processing for equalizing the remaining capacities of the plurality of battery cells incorporated in the power supply device as a whole.

### BRIEF DESCRIPTION OF THE DRAWINGS

FIG. 1 is a block diagram schematically illustrating a power supply device 10 disclosed herein.

### DETAILED DESCRIPTION

Hereinbelow, the present disclosure will be described in detail. Unless otherwise stated, the present disclosure is not intended to limit the invention as set forth in the appended claims. The drawings are depicted schematically and do not necessarily accurately depict actual objects. The features and components that exhibit the same effects are designated by the same reference symbols as appropriate, and the description thereof will not be repeated.

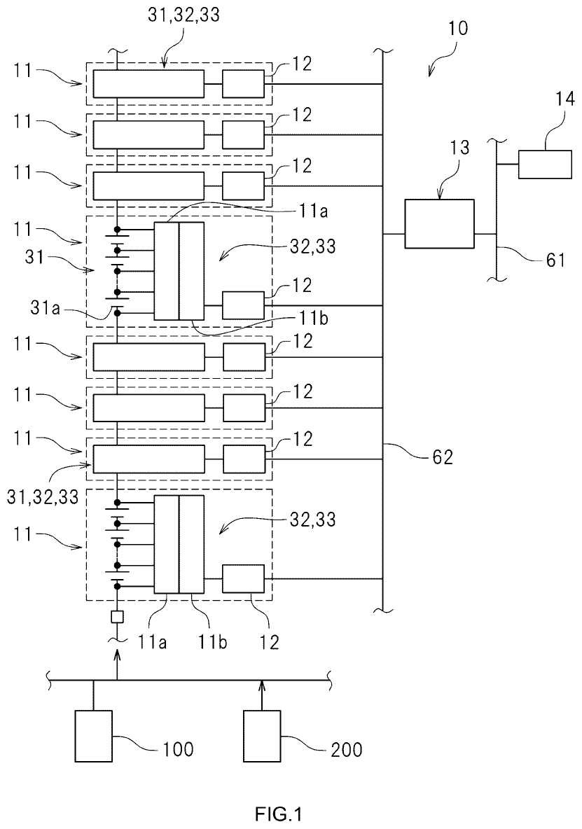

FIG. 1 is a block diagram schematically illustrating a power supply device 10 disclosed herein. The power supply device 10 includes a plurality of battery modules 11 and a higher-level controller 13. In FIG. 1, the internal structure of some of the battery modules 11 is shown unfolded. Note that the battery modules 11 whose internal structure is not shown unfolded also have the same structure as that of the battery modules 11 whose internal structure is shown unfolded. In the embodiment shown in FIG. 1, the plurality of battery modules 11 are connected in series and are connected to a load 100 (a drive device such as an electric motor) of a vehicle, an external power supply 200, and so forth.

Each of the battery modules 11 incorporates a lower-level controller 12. The lower-level controllers 12 are communicably connected to the higher-level controller 13. The lower-level controllers 12 are controllers that control the battery modules 11, and the higher-level controller 13 is a controller that controls the plurality of battery modules 11 incorporated in the power supply device 10 so as to cooperate with each other. The higher-level controller 13 may be communicably connected to, for example, an external controller 14 (on-board ECU). In the embodiment shown in FIG. 1, the external controller 14 (such as an on-board ECU) that is provided external to the power supply device 10 is connected to the higher-level controller 13 by a communication channel 61. The lower-level controllers 12 that control the plurality of battery modules 11 are connected to the higher-level controller 13 by a common communication channel 62. Note that the power supply device 10 is not limited to the embodiment shown in FIG. 1. For example, the external controller 14 (such as on-board ECU) may be connected to the communication channel 62 to which the higher-level controller 13 and the lower-level controllers 12 are connected.

### Battery Module 11

Herein, each of the battery modules 11 includes a plurality of battery cells 31, a detection unit 32, an equalization processor 33, and a lower-level controller 12.

### Plurality of Battery Cells 31

The plurality of battery cells 31 are a battery group in which a predetermined number of single cells are connected in series. The plurality of battery cells 31 may include, for example, a plurality of single cells arranged in a row. In addition, the plurality of battery cells 31 may be connected in series successively by a bus bar. Herein, the term “plurality of battery cells” refers to a plurality of battery cells contained in a battery module 11, while the term “single cell” refers to each single cell contained in the battery module 11.

In such a battery module 11, during discharge, the cell that shows the lowest remaining capacity may impose a restriction on discharging from the viewpoint of preventing overdischarge. On the other hand, during charge, the cell that shows the highest remaining capacity may impose a restriction on charging from the viewpoint of preventing overcharge. When the remaining capacities of the single cells 31a contained in the battery modules 11 are uniform, the restriction on charge and discharge is more unlikely to be imposed than when the remaining capacities of the single cells 31a are uneven, so the battery modules 11 are able to exhibit higher performance.

In this embodiment, each of the battery modules 11 includes an equalization circuit 11a and a detection circuit 11b, as the hardware configurations that embody various processes of the detection unit 32 and the equalization processor 33, respectively.

### Detection Unit 32

The detection unit 32 is a unit that detects the remaining capacity of each of the plurality of battery cells 31. Herein, the remaining capacity is also referred to as “SOC”. The acronym “SOC” stands for state of charge. The remaining capacity (SOC) is obtained from the equation: Remaining capacity (SOC)=(Cr/Cf)×100 (%). Here, Cr is the remaining capacity [Ah], Cf is the fully charged capacity [Ah], and the unit [Ah] represents the amount of charge stored in the battery.

It is difficult to directly detect the remaining capacity of each of the plurality of battery cells 31. The remaining capacity is estimated, for example, from the battery voltage. The remaining capacity may also be estimated, for example, from the history of the charge-discharge current value. In this embodiment, the detection unit 32 may acquire the information for detecting the remaining capacity of each of the plurality of battery cells 31 and obtain the remaining capacity of each of the single cells based on the acquired information. In the embodiment shown in FIG. 1, the detection unit 32 may be configured so that the temperature, voltage, and current value of each of the single cells 31a are obtained through the detection circuit 11b for detecting measurement values concerning the battery state of each of the single cells 31a contained in the battery module 11.

For example, the temperature may be measured with a temperature sensor. The temperature sensor may be provided for each of the single cells 31a of the battery modules 11. It is also possible that the temperature of each of the single cells 31a may be estimated with some of the temperature sensors provided in the battery module 11. For example, when the single cells 31a are arranged in a row in the battery module 11, the temperature of each single cell 31a may be obtained based on the distance between the temperature sensor provided at the central portion of the battery module 11 and the temperature sensors provided at both ends of the battery module 11. The voltage value may be obtained based on a voltage sensor provided for each of the single cells 31a. The current value may be obtained by a current sensor 20 that detects the current flowing in the battery module 11. Thus, the detection unit 32 may be one that detects the remaining capacity of each of the plurality of battery cells 31 based on the temperature, voltage, or current value. The detection unit 32 may include, for example, a part that acquires information such as temperature, voltage, or current values from various types of sensors, and a part that acquires the remaining capacity based on the acquired information.

### Lower-Level Controller 12

The lower-level controller 12 is configured to execute a process of setting a target value for equalizing the remaining capacities of the plurality of battery cells 31 based on the remaining capacities of the plurality of battery cells 31 that have been detected by the detection unit 32. The power supply device 10 includes a plurality of battery modules 11. The plurality of battery modules 11 are controlled by respective lower-level controllers 12 independently from one another so that the remaining capacities of the plurality of battery cells 31 incorporated in the battery modules 11 can be equalized. Each of the battery modules 11 may include a microcomputer incorporated therein. The lower-level controller 12 may be embodied by, for example, one of the functions of the microcomputer incorporated in each of the battery modules 11.

### Equalization Processor 33

The equalization processor 33 is a unit that executes a process of equalizing the remaining capacities of the plurality of battery cells 31 according to the target value set by the lower-level controller 12.

In this embodiment, the battery module 11 incorporates an equalization circuit 11a for equalizing the remaining capacities of the plurality of battery cells 31 according to the target value set by the lower-level controller 12. The equalization circuit 11a may have a circuit configuration such that, for example, a closed circuit is formed in which a resistor connected to each of the single cells 31a, and the opening and closure of the closed circuit is controlled by a switch. When a single cell 31a is short-circuited to a resistor, the electric power of the single cell 31a is consumed, reducing the remaining capacity of the relevant single cell 31a. In this case, in the equalization process, the target value for equalization may be set to the remaining capacity of one of the single cells 31a that shows the lowest remaining capacity in the battery module 11.

In this embodiment, in the process of equalizing the remaining capacities of the plurality of battery cells 31 contained in the battery module 11, the equalization circuit 11a may be controlled according to the target value set by the lower-level controller 12. The lower-level controller 12 obtains the remaining capacity of each of the single cells 31a based on the information, such as the temperature, voltage, and current value, of each of the single cells 31a that is acquired from the detection circuit 11b. Then, the lower-level controller 12 may set the target value for equalization to be the remaining capacity of one of the single cells 31a that has the lowest remaining capacity in one battery module 11. By setting the target value for equalization and controlling the equalization circuit 11a in this way, the target value for equalization can be matched to the remaining capacity of one of the single cells 31a that shows the lowest remaining capacity in the battery module 11. This makes it possible to equalize the remaining capacity of the plurality of battery cells 31 within the battery module 11.

When all the single cells 31a incorporated in the plurality of battery modules 11 incorporated in the power supply device 10 have the same battery capacity and the plurality of battery modules 11 are connected in series, it is desirable that the remaining capacities of all the single cells 31a incorporated in the plurality of battery modules 11 incorporated in the power supply device 10 be equalized as a whole. When the remaining capacities of all the single cells 31a incorporated in the plurality of battery modules 11 incorporated in the power supply device 10 are equalized as a whole in this case, the target value for equalization may be set, for example, based on the remaining capacity of one of the single cells 31a that shows the lowest remaining capacity, among all the single cells 31a incorporated in the plurality of battery modules 11 incorporated in the power supply device 10.

Electric vehicles, which obtain propulsion power with electricity through an electric motor, use a power supply device that includes a plurality of battery modules as a power supply for propelling the vehicles. Among them, battery electric vehicles (BEV) that are purely driven based on the electric power stored in batteries necessitate a large number of cells to be built into one vehicle, in order to increase the travel range achieved per full charge. In this case, when the number of batteries to be incorporated in a vehicle is greater, the arithmetic processing for the equalization process becomes more complicated correspondingly.

For example, in the example of FIG. 1, 8 battery modules 11 are connected in series. When there are 8 battery modules each including 25 single cells 31a so that 200 cells in total are connected in series, the battery data of each of the 200 cells may be collected respectively and a target value for equalization may be set. When two times the number (i.e., 16) of battery modules 11 are connected in series, it means that 400 cells in total are connected in series. In this case, for example, battery information (for example, voltage information) may be collected from the 400 cells, and the target value for equalization may be set through a predetermined arithmetic operation. It is also expected that the number of battery cells connected in series may increase further as a whole. Thus, the greater the number of battery modules connected in series, the greater the number of cells connected in series as a whole within the overall power supply device 1. Here, assuming that the voltage per one cell is 4.3 V and when 25 cells×8 modules, i.e., a total of 200 cells, are connected in series, the total voltage obtained is 860 V. When 25 cells×16 modules, a total of 400 cells, are connected in series, the total voltage obtained is 1,720 V. When 25 cells×32 modules, a total of 800 cells, are connected in series, the total voltage obtained is 3,440 V. Thus, the greater the number of cells, the higher the voltage that can be obtained. On the other hand, it is expected that the amount of battery information that needs to be collected for setting a target value for equalization may increase, and that the communication load or arithmetic processing load may become greater.

### Higher-Level Controller 13

The power supply device 10 shown in FIG. 1 includes a higher-level controller 13. In the power supply device 10 shown in FIG. 1, the higher-level controller 13 is configured to execute a first process. In addition, a plurality of lower-level controllers 12 are configured to execute a second process.

### First Process

The first process is a process of setting an adjusting value for adjusting the target values that are respectively set by the lower-level controllers 12 of the plurality of battery modules 11. For example, in the first process, the higher-level controller 13 acquires the target values that are respectively set by the lower-level controllers 12 of the plurality of battery modules 11. The higher-level controller 13 sets the adjusting value to be the lowest one of the plurality of target values that are acquired from the plurality of lower-level controllers 12. In this case, the information sent from the lower-level controllers 12 to the higher-level controller 13 is the target values for equalization only. The higher-level controller 13 sets the adjusting value based on the target values for equalization that have been sent from the lower-level controllers 12. The number of the target values for equalization that are sent from the lower-level controllers 12 is equal to the number of the battery modules 11, which is considerably less than the number of the single cells 31a incorporated in the battery modules 11.

### Second Process

The second process is a process in which, when the adjusting value is set in the first process, the plurality of lower-level controllers 12 update their target values that are set respectively by the lower-level controllers 12 based on the adjusting value. In such a second process, the adjusting value that has been set by the higher-level controller 13 is sent to the plurality of lower-level controllers 12. The plurality of lower-level controllers 12 each update the target values based on the adjusting value. In this case, the amount of information communicated between the higher-level controller 13 and the lower-level controllers 12 is small, and the information of processing executed by the lower-level controllers 12 is also small.

As a result of such a second process, each of the lower-level controllers 12 updates the target value for equalizing the remaining capacities of the plurality of battery cells 31 that are incorporated in the battery module 11 that is the subject of controlling by the lower-level controller 12. Thus, in the lower-level controllers 12 of the battery modules 11 in the power supply device 10, the target value for equalizing the remaining capacities of the plurality of battery cells 31 incorporated in the battery modules 11 matches the adjusting value adjusted by the higher-level controller 13. In each of the battery modules 11, an equalization process is executed based on the target value updated by the lower-level controllers 12. As a result, the remaining capacities of all the single cells 31a incorporated in each of the battery modules 11 are equalized based on the adjusting value adjusted by the higher-level controller 13.

Thus, the first the second processes as described above are executed in the power supply device 10 in order to equalize the remaining capacities of all the single cells 31a incorporated in the battery modules 11 of the power supply device 10. In the first process and the second process as described above, the amount of information communicated between the higher-level controller 13 and the lower-level controllers 12 is small. Moreover, the process of updating the target value set by the lower-level controllers 12 to the adjusting value set by the higher-level controller 13 also requires a less amount of processing. The amount of communications and the amount of processing that are required in the first process and the second process do no increase so much even when the number of battery modules connected in series in the power supply device 10 increases.

In this embodiment, the lower-level controllers 12 are configured to set a target value for equalization to be the remaining capacity of one of the single cells 31a that has the lowest remaining capacity among the plurality of single cells 31a incorporated in the battery module 11 that is the subject of controlling. The higher-level controller 13 is configured to set the adjusting value to be the lowest one of the plurality of target values acquired from the plurality of lower-level controllers 12. The higher-level controller 13 sets the adjusting value to be the lowest one of the plurality of target values that are acquired from the lower-level controllers 12.

The lower-level controllers 12 execute a second process of updating respective target values that are set by the lower-level controllers 12. Executing the second process causes the target values set in the respective lower-level controllers 12 to be the adjusting value set by the higher-level controller 13. Thus, the remaining capacities of the plurality of battery cells 31 incorporated in the battery module 11 that is the subject of controlling by each of the lower-level controllers 12 are equalized according to the adjusting value that is set by the higher-level controller 13. Thereby, the remaining capacities of all the single cells 31a incorporated in the power supply device 10 are equalized. Here, the higher-level controller 13 sets the adjusting value to be the lowest one of the plurality of target values that are acquired from the lower-level controllers 12. As a result, the remaining capacities of all the single cells 31a incorporated in the power supply device 10 are equalized to be the lowest one of the target values that are acquired from the respective lower-level controllers 12. In this case, in the process of achieving the equalization to match the remaining capacities of the single cells 31a to the remaining capacity of one of the single cells 31a that shows the lowest remaining capacity, the single cells 31a that have higher remaining capacities may be short-circuited to resistors. This serves to simplify the circuit configuration and processing for achieving equalization.

In the power supply device 10 shown in FIG. 1, 8 battery modules 11 are connected in series. Let us assume that each of the battery modules 11 incorporates 25 single cells 31a connected in series. In this case, a total of 200 single cells 31a are connected in series in the power supply device 10 as a whole. In the power supply device 10, in equalizing the remaining capacities of the 200 single cells 31a connected in series as a whole, the target values that are set in the lower-level controllers 12 of the 8 battery modules 11 are transmitted to the higher-level controller 13, and the adjusting value is set by the higher-level controller 13. Then, each of the lower-level controllers 12 in the respective battery modules 11 updates the target value according to the adjusting value. As a result, the remaining capacities of the 200 single cells 31a connected in series as a whole are equalized in the power supply device 10. Furthermore, also when four times the number (i.e., 32) of battery modules 11 are connected in series and a total of 800 cells are connected in series, the higher-level controller 13 may execute the process of setting the adjusting value based on the target values for equalization that have been sent from the respective lower-level controllers 12. This means that the amount of information collected for setting the target value for equalization is smaller, and accordingly, the communication load between the higher-level controller 13 and the lower-level controllers 12 and the processing load are lower. In other words, the power supply device 10 does not need to collect all the information of the remaining capacities of all the single cells 31a incorporated in the power supply device 10 to set the target value for equalization, so the communication load and the processing load are significantly lighter.

The higher-level controller 13 may function when equalizing the remaining capacities between the plurality of battery modules 11 incorporated in the power supply device 10. The remaining capacities of the plurality of battery modules 11 incorporated in the power supply device 10 may be equalized when the power supply device 10 is connected to and charged by an electric power supply 200 through a charging spot. Specifically, in the case where the power supply device 10 is built into an electric vehicle, the remaining capacities may be equalized between the plurality of battery modules 11 when the power supply device 10 is charged while electric vehicle is at standstill. For example, in the power supply device 10 incorporated in an electric vehicle, the lower-level controllers 12 measure variations in the remaining capacities between the plurality of battery modules 11 and determine the capacities and the cells to be discharged, at the time when the power of the vehicle is turned on. The remaining capacities of the plurality of battery modules 11 incorporated in the power supply device 10 may be equalized in the cycle of power-on, driving, power-off, and charging.

In addition, when the higher-level controller 13 is not activated, the lower-level controllers 12 control the battery modules 11 independently from each other to equalize the plurality of battery cells 31, to equalize the remaining capacities of the plurality of battery cells 31 incorporated in each of the battery modules 11. After the higher-level controller 13 is activated, the lower-level controllers 12 incorporated in the plurality of battery modules 11 transmit the target values to the higher-level controller 13. Then, according to the adjusting value set by the higher-level controller 13, the lower-level controllers 12 update the target values for respectively equalizing the remaining capacities of the plurality of battery cells 31 incorporated in the plurality of battery modules 11. In this way, when the higher-level controller 13 is not activated, the lower-level controllers 12 independently equalize the remaining capacities of the plurality of battery cells 31 incorporated in the plurality of battery modules 11. When the higher-level controller 13 is activated, the lower-level controllers 12 update the target values for respectively equalizing the remaining capacities of the plurality of battery cells 31 incorporated in the plurality of battery modules 11 according to the adjusting value set by the higher-level controller 13.

In the foregoing description, it is assumed that each of the battery modules 11 in the power supply device 10 is in communication with the higher-level controller 13. However, the power supply device 10 also functions even when a failure occurs such that some of the battery modules 11 of the power supply device 10 are not in communication with the higher-level controller 13. More specifically, the lower-level controllers 12 incorporated in the battery modules 11 of the power supply device 10 are configured to execute a process of setting a target value for equalizing the remaining capacities of the plurality of battery cells 31 incorporated in the battery modules 11, independently from each other. As a result, even when a failure occurs such that some of the battery modules 11 of the power supply device 10 are not in communication with the higher-level controller 13, the remaining capacities of the plurality of battery cells 31 are not equalized based on the adjusting value, in the battery modules 11 in which the failure occurs. However, the remaining capacities of the plurality of battery cells 31 in the battery modules 11 in failure are equalized based on the target value set by the lower-level controllers 12. Thus, even when a failure occurs such that some of the battery modules 11 of the power supply device 10 are not in communication with the higher-level controller 13, the remaining capacities of the plurality of battery cells 31 are equalized in each of the battery modules 11. On the other hand, in the other battery modules 11 that are not in failure, the remaining capacities of the plurality of battery cells 31 are equalized based on the adjusting value set by the higher-level controller 13. Even when some of the plurality of battery modules 11 are in failure, such as a communication failure, it is possible to recover the power supply device 10 as a whole by replacing one(s) of the battery modules 11 in failure.

In addition, the higher-level controller 13 may be configured so that the number of battery modules 11 connected to the higher-level controller 13 can be increased or decreased. In addition, the higher-level controller 13 may be configured so that the number of battery modules 11 connected to the higher-level controller 13 can be increased or decreased. This allows the power supply device 10 to easily replace or add the battery modules 11 one by one, making it easier to carry out maintenance and to change the overall capacity.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

### Item 1:

A power supply device includes:
a plurality of battery modules connected in series; and
a higher-level controller, wherein:
each of the plurality of battery modules includes:
   a plurality of battery cells connected in series;
   a detection unit detecting respective remaining capacities of the plurality of battery cells;
   a lower-level controller configured to execute a process of setting a target value for equalizing the remaining capacities of the plurality of battery cells based on the remaining capacities of the plurality of battery cells that are detected by the detection unit; and
   an equalization processor for equalizing the remaining capacities of the plurality of battery cells according to the target value set by the lower-level controller, wherein:
the higher-level controller is configured to execute a first process of setting an adjusting value for adjusting the target value set by the lower-level controller of each of the plurality of battery modules; and
the lower-level controllers of the plurality of battery modules are configured to execute a second process of updating the target value that are set respectively by the lower-level controllers.

### Item 2:

The power supply device according to item 1, wherein:
when equalizing the remaining capacities between the plurality of battery modules,
   the higher-level controller transmits the adjusting value to the lower-level controllers of the plurality of battery modules; and
   each of the lower-level controllers is configured to receive the adjusting value from the higher-level controller and update the target value based on the adjusting value, to control the equalization processor of a corresponding one of the battery modules based on the updated target value.

### Item 3:

A power supply device according to item 1, wherein each of the lower-level controllers is configured to set the target value to be a remaining capacity of one of the battery cells having the lowest remaining capacity among the plurality of battery cells incorporated in the battery module.

### Item 4:

A power supply device according to item 3, wherein the higher-level controller is configured to set the adjusting value to be the lowest one of the plurality of target values acquired from the lower-level controllers.

1. A power supply device comprising:
a plurality of battery modules connected in series; and
a higher-level controller, wherein:
each of the plurality of battery modules includes:
a plurality of battery cells connected in series;
a detection unit detecting respective remaining capacities of the plurality of battery cells;
a lower-level controller configured to execute a process of setting a target value for equalizing the remaining capacities of the plurality of battery cells based on the remaining capacities of the plurality of battery cells that are detected by the detection unit; and
an equalization processor for equalizing the remaining capacities of the plurality of battery cells according to the target value set by the lower-level controller, wherein:
the higher-level controller is configured to execute a first process of setting an adjusting value for adjusting the target value set by the lower-level controller of each of the plurality of battery modules; and
the lower-level controllers of the plurality of battery modules are configured to execute a second process of updating the target value set respectively by the lower-level controllers.

2. The power supply device according to claim 1, wherein:
when equalizing the remaining capacities between the plurality of battery modules,
the higher-level controller transmits the adjusting value to the lower-level controllers of the plurality of battery modules; and
each of the lower-level controllers is configured to receive the adjusting value from the higher-level controller and update the target value based on the adjusting value, to control the equalization processor of a corresponding one of the battery modules based on the updated target value.

3. The power supply device according to claim 1, wherein each of the lower-level controllers is configured to set the target value to be a remaining capacity of one of the battery cells having the lowest remaining capacity among the plurality of battery cells incorporated in the battery module.

4. The power supply device according to claim 3, wherein the higher-level controller is configured to set the adjusting value to be the lowest one of the plurality of target values acquired from the lower-level controllers.
